(19) United States
(12) Patent Application Publication
(10) Pub. No.: US 2014/0196636 A1
(43) Pub. Date: Jul. 17, 2014

(54) SAFE WEAPON CONTAINER FOR SECURELY RELEASING A DEFENSE WEAPON

(71) Applicants: TIMOTHY DEWEESE, LOS ALAMITOS, CA (US); BRANDON DELIBRO, LOS ALAMITOS, CA (US)

(72) Inventors: TIMOTHY DEWEESE, LOS ALAMITOS, CA (US); BRANDON DELIBRO, LOS ALAMITOS, CA (US)

(21) Appl. No.: 14/156,410

(22) Filed: Jan. 15, 2014

Related U.S. Application Data
(60) Provisional application No. 61/753,067, filed on Jan. 16, 2013.

(51) Int. Cl. E05G 1/02

(52) U.S. Cl. CPC E05G 1/02
USPC 109/23

(57) ABSTRACT

Some embodiments of the invention provide a safe weapon container for securely holding a defense weapon that is only accessible to an authorized user upon one or more successful biometric inputs that authenticate the identity of the authorized user. The safe weapon container includes a safe, a surveillance camera, an audio intercom, a biometric input device, a door status contact device, a tamper switch, a delay release lock, and an internet protocol (IP) module.

### CLAIM OF BENEFIT TO PRIOR APPLICATION

This application claims benefit to U.S. Provisional Patent Application 61/753,067, entitled “Safe Weapon Container For Securely Releasing A Defense Weapon,” filed Jan. 16, 2013. The U.S. Provisional Patent Application 61/753,067 is incorporated herein by reference.

### BACKGROUND

Embodiments of the invention described in this specification relate generally to gun safes, and more particularly, to gun safe security.

Many people spend a substantial amount of time in areas that are considered to be free of guns. The notion that some areas of daily life are free of guns is supported by social norms that shape expectations and behavior. For example, people typically do not bring guns to schools, places of religious worship, maternity wards, etc. While it is largely true that most people in gun free environments are not armed, massacres of people in gun free zones are on the rise because the killers know that the victims have limited means of protection. In particular, such massacres are occurring more often than not at schools with children. When a person is prepared to commit malicious and capital offenses, laws preventing the person from carrying a gun into a school zone are largely incapable of working Because schools are (by law and social norm) gun free zones, preventing such massacres is exceedingly difficult. For instance, a would-be killer who is not deterred by criminal punishment arising out of a murder conviction is capable of randomly killing multiple defenseless children and teachers. As students, teachers, and school administrators do not arm themselves in school zones, schools must rely on the proper enforcement authorities (e.g., police) to protect the children. However, before the police can incapacitate (e.g., kill or apprehend) the killer, there is a window of time for the killer to shoot and kill many children. For instance, even under the best conditions, it could take several minutes for police to arrive at the school and incapacitate the killer.

A weapon cabinet (e.g., a gun cabinet) could be utilized to solve this timing problem. By equipping teachers and/or school administrators with the means of protection, many lives could be saved. Current gun cabinets may include unlock devices to ensure that the guns in the cabinet are only accessible to authorized personnel. However, such gun cabinets typically do not include routine (e.g., 24 hours per day, 7 days per week) monitoring upon activation. Furthermore, these gun cabinets are not suited for massacre situations that may require live video recording, two-way voice communication, and/or dispatching capabilities. For example, even if a killer enters a classroom and is incapacitated by a gunshot wound from the teacher, several other co-conspirator killers may be acting in concert to kill as many people as possible.

### BRIEF SUMMARY

Some embodiments of the invention provide a safe weapon container for securely holding a defense weapon that is only accessible to an authorized user upon one or more successful biometric inputs that authenticate the identity of the authorized user. The safe weapon container includes a safe, a surveillance camera, an audio intercom, a biometric input device, a door status contact device, a tamper switch, a delay release lock, and an internet protocol (IP) module.

In some embodiments, when a biometric input is received for opening the gun safe, recording of live video and audio is initiated at the site of the safe weapon container. In some embodiments, the live video and audio is transmitted to a central command facility. In some embodiments, the video and audio is streamed over the Internet to the central command facility. In some embodiments, the safe weapon container receives an input from the central command facility. In some embodiments, the input from the central command facility is a signal that is responsive to the biometric input for opening the gun safe. In some embodiments, the signal is one of a stop signal, a delay signal, and a release signal. When the safe weapon container receives a stop signal, the gun safe does not release the gun. When the safe weapon container receives a release signal, the gun safe releases the gun. When the safe weapon container receives a delay signal, the gun safe performs at least one of signaling an error and waiting for additional input.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a safe weapon container in some embodiments which receives a biometric input to open the interior of a gun safe.

FIG. 2 conceptually illustrates a block diagram of a monitored release system of a gun safe that securitizes a defense weapon in some embodiments.

FIG. 3 conceptually illustrates a process for securitizing a defense weapon in a gun safe in some embodiments.

FIG. 4 conceptually illustrates another block diagram of a monitored release system of a gun safe that securitizes a defense weapon in some embodiments.

FIG. 5 conceptually illustrates an example of an authorized user accessing a shotgun from the interior of a safe weapon container during an emergency.

FIG. 6 conceptually illustrates an example of a user being denied access to a shotgun after a central command facility reviews live audio and video of a non-emergency scene.

FIG. 7 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention provide a novel safe weapon container for securely holding a defense weapon that is only accessible to an authorized user upon one or more successful biometric inputs that authenticate the identity of the authorized user. The safe weapon container includes a body, a surveillance camera, an audio intercom, an IP communication interface, a biometric input device, a door status contact device, a tamper switch, and a delay release lock.

The safe weapon container of some embodiments includes a gun safe cabinet that is large enough to house a shot gun. The safe weapon container protects the gun from unauthorized use and tampering. In some embodiments, the gun safe cabinet satisfies UL TL-15 rating standards for gun safes.

When an authorized gun user feels there is a threat that requires lethal force in order to defend their self or others, he or she would present their finger to the biometric finger reader. In some embodiments, when biometric input is received for opening the gun safe, recording of live video and audio is initiated at the site of the safe weapon container. In some embodiments, the live video and audio is transmitted to a central command facility where trained personnel can evaluate the situation (e.g., by viewing and listening and deciding whether or not lethal force is necessary). In some embodiments, the video and audio is streamed over the Internet to the central command facility.

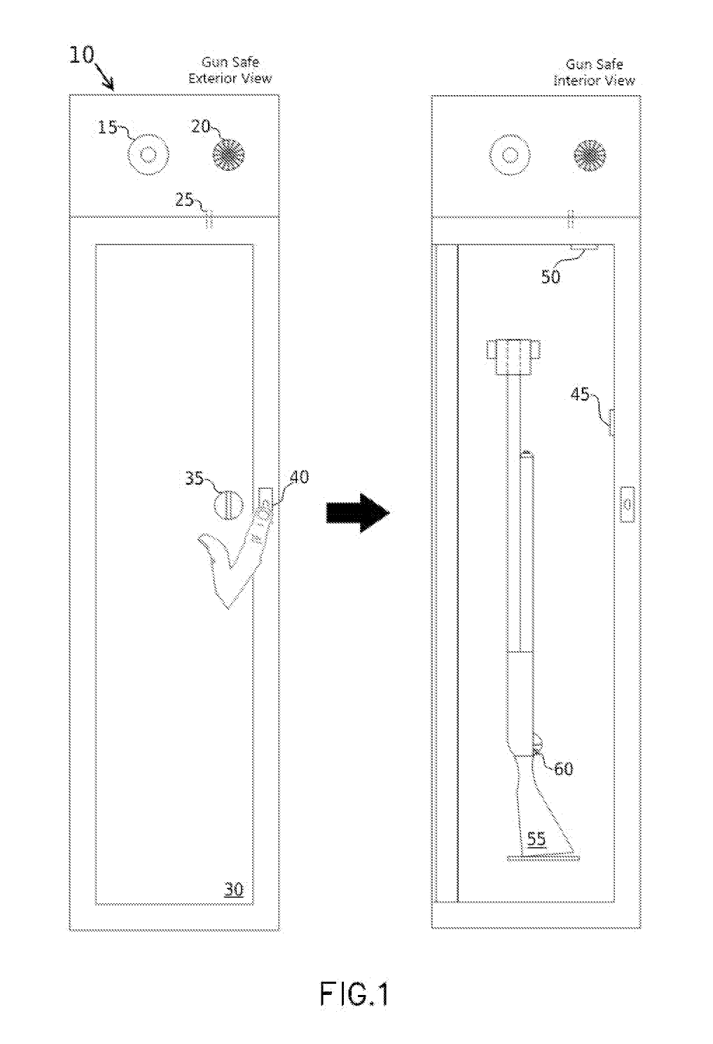

By way of example, FIG. 1 conceptually illustrates a safe weapon container which receives a biometric input to open the interior of a gun safe. As shown in this figure, the safe weapon container 10 includes a surveillance camera 15, an audio intercom 20, a small aperture 25 (for wired or wireless data communications), a cabinet door 30, a door handle 35, and a biometric input device 40. A hand of a user is present about the biometric input device, with a finger positioned approximately over a fingerprint scanner. After the fingerprint is received, the surveillance camera 15 and audio intercom 20 are initiated to provide live audio and video feeds to a central monitoring facility. The live audio and video provides a second level of access authentication that ensures safe release of a defense weapon. In this example, the first level of access authentication is a fingerprint, which if matched to a stored fingerprint image of an authorized gun safe user, identifies the person attempting to access the defense weapon. The second level of access authentication occurs automatically by transmission of the live audio and video. When the central command facility receives the live audio and video streams, a monitoring agent (e.g., a person at central command) is able to determine whether the situation at the scene of the safe weapon container warrants immediate release of the defense weapon. For instance, the monitoring agent may see an armed attacker wounding innocent and unarmed victims, and may then release the defense weapon to the authorized user.

When the cabinet door 30 is open, the interior of the safe weapon container 10 is accessible. Within the interior, the safe weapon container 10 includes a door status contact device 45, a tamper switch 50, a defense weapon 55, and a delay release lock 60. The defense weapon can be a gun, a taser, a knife, etc. The weapon 55 in this example is a shot gun 55.

The surveillance camera 15 allows central command personnel to view the person requesting that the cabinet door 30 be opened to access the defense weapon 55. In some embodiments, the surveillance camera 15 is a high resolution IP surveillance camera. In some embodiments, the central command personnel have multiple views of the person, including close-up macro views of the biometric input of the person (e.g., fingerprint, retina, etc.), facial close-ups, and wider views of the whole person and the overall situation at the site of the safe weapon container 10. This enables the central command personnel to evaluate the situation and override the release of the gun if unnecessary.

The audio intercom 20 in some embodiments is a two-way audio receiver/transmitter between the site of the safe weapon container and the central command facility. The audio intercom 20 of some embodiments is activated once the biometric request is initiated. This allows the central command facility to immediately and conveniently communicate with the requester.

The small aperture 25 in some embodiments includes an IP communication interface for wired or wireless data communications. The IP communication interface allows communication to the central command center via the Internet. In some embodiments, the IP communication interface includes a program with a graphical user interface (GUI). In some embodiments, the program can be loaded on a mobile computing device, such as a mobile communications device or a tablet computing device, which displays the GUI when operating on the mobile device. The GUI includes information for the person requesting access to the gun safe. In some embodiments, the GUI includes a set of user tools that allow the person to input information. The user input is transmitted to the central command facility to allow the personnel to evaluate information posted by the person requesting access to the gun safe 10. In this way, an authorized user of the gun safe can be physically located more than reaching distance to the gun safe, yet can still obtain access to the gun safe. For instance, the person may be running into an emergency situation and simultaneously using a mobile device to ensure that the defense weapon is released upon arrival at the gun safe.

The biometric input device 40 of some embodiments is a reader that scans a unique pattern (e.g., a fingerprint, a retina, etc.) of the person accessing the gun safe 10. In some embodiments, the biometric input device 40 is a fingerprint reader for validating that the person requesting access to the gun safe is approved for gun use. By equipping a classroom with a secured gun cabinet holding a single shotgun 55, the teacher could access the shotgun through fingerprint identification technology.

The door status contact device 45 of some embodiments is a trigger which transmits a signal to the central command center as to whether the gun safe door has been opened. For example, after central command personnel release and the person tries to open the cabinet door 30, the door status contact device 45 may send a positive verification that the gun safe cabinet door 30 has been opened.

During any attempt to access the shot gun 55, the gun safe 10 determines the intended use of the gun. In some embodiments, the gun safe 10 does not release the gun for any unauthorized use (e.g., offensive or illegal). The tamper switch 50 of some embodiments notifies the central command center that someone is tampering with or attempting to gain unauthorized access to the gun safe. For example, an unauthorized user is attempting to open the gun safe door 30 without entering biometric authentication input, such as a fingerprint or retina scan. When the tamper switch 50 is activated in some embodiments, both video and audio is transmitted to the central command center. In this manner, the central command personnel can evaluate whether the unauthorized access is from an actual unauthorized user or simply due to a mistake by an authorized user.

The delay release lock 60 of some embodiments is a trigger lock that physically secures the shotgun 55 inside the safe weapon container 10 and, while the gun is secured, prevents the gun from being discharged in the safe weapon container 10. In some embodiments, the delay release lock 60 secures the gun for a period of time in order to allow the central command station to deny the release of the shot gun if warranted.

In addition to audio and video feeds, in some embodiments, two-way communication between a person accessing the shot gun and the central command facility is started. Moreover, authorities (e.g., police) are automatically notified and the surveillance camera starts recording and storing video and audio in a data storage device (i.e., a database).

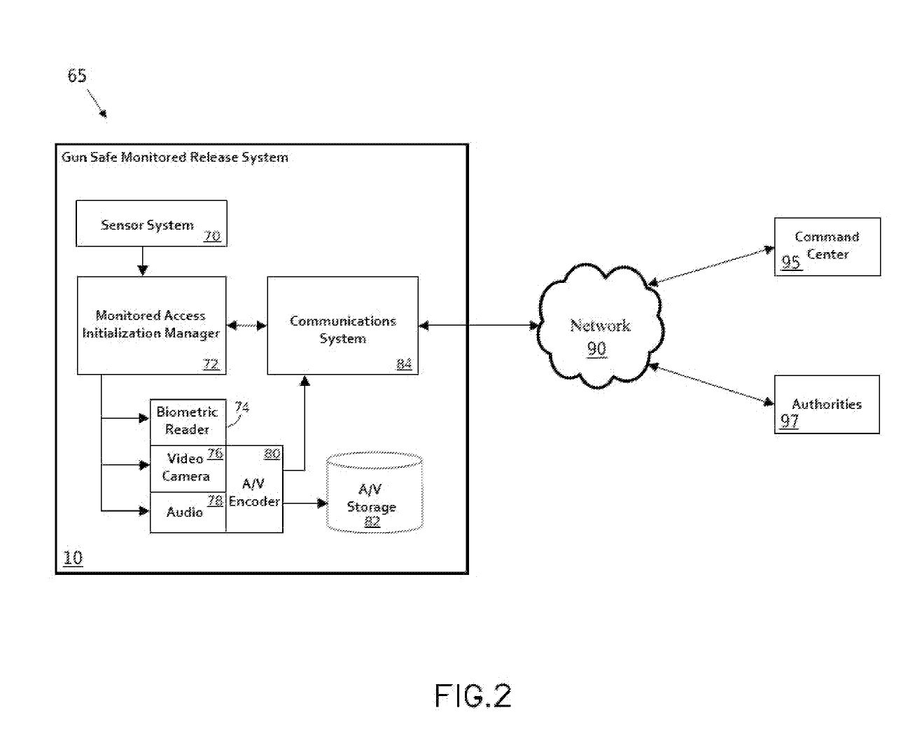

FIG. 2 conceptually illustrates a block diagram of a monitored release system of a gun safe that securitizes a defense weapon in some embodiments. As shown in this figure, the gun safe monitored release system 65 includes a safe weapon container (i.e., gun safe) 10 that is communicably connected over a network 90 to a central command facility 95 and one or more authorities 97. In particular, the gun safe 10 includes a sensor system 70, a monitored access initialization manager 72, a biometric reader 74, a video camera 76, audio intercom 78, an audio-visual (A/V) encoder 80, A/V storage 82, and a communications system 84. As there are no gun safes to date that have live video and audio communication with a central control facility, the benefits of automatically starting live video and audio communication with the central control facility are in allowing central command personnel to evaluate the situation.

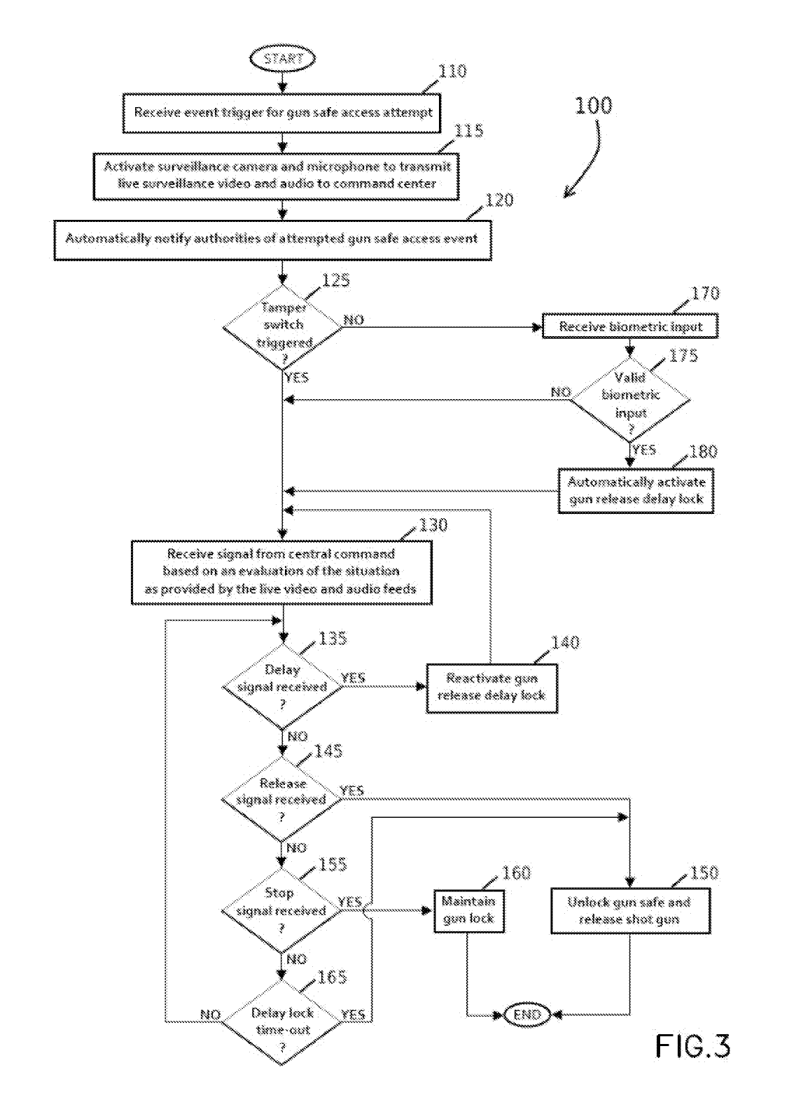

In some embodiments, the safe weapon container receives an input from the central command facility. In some embodiments, the input from the central command facility is a signal that is responsive to the biometric input for opening the gun safe. FIG. 3 conceptually illustrates a process for receiving access signals from a central command facility in securitizing a defense weapon in a gun safe in some embodiments. The process of some embodiments is performed by a program running on a processing unit embedded in an electronic system of the safe weapon container.

In some embodiments, the process 100 starts upon receiving (at 110) an event trigger associated with an attempted access of the gun safe. The attempted access may be a fingerprint scan, a retina scan, another type of biometric input, or a person physically handling (i.e., kicking, pushing, pulling, tilting, etc.) the gun safe. Whatever the cause of the trigger, in some embodiments the process activates (at 115) the surveillance camera and audio intercom to transmit lives video and audio to the central command center. In some embodiments, the process automatically notifies (at 120) the authorities of the attempted gun safe access. The authorities are notified whether the attempt is by an authorized person for a valid emergency situation, by an authorized person for an invalid, non-emergency situation, or by an unauthorized user.

In any event, the process does perform different sets of operations depending on the type of attempted access. Thus, the process 100 next determines (at 125) whether the tamper switch was triggered. If the tamper switch was triggered, the process waits to receive (at 130) a signal from the central command center, which is described in further detail below. On the other hand, if the process determines that the tamper switch was not triggered, then the attempted access must have been a biometric input.

In some embodiments, the process 100 receives (at 170) the biometric input. The biometric input may be a fingerprint, a retina scan, or some other biometric input that uniquely identifies an authorized user of the gun safe. However, any person can attempt to provide a biometric input in the hopes of inappropriately gaining authorized access. In doing so, the process determines (at 175) whether the biometric input is valid. In some embodiments, the process searches through a set of biometric data stored in a database of authorized user biometric structures. For example, the process may compare one or more characteristics, such as size, print diameter, print pattern, etc., present in an image of a person's fingerprint, with corresponding characteristics of a set of stored fingerprint images of authorized users. If the biometric input is not valid, the process transitions to 130, to receive a signal from central command, which is further described below. However, when the biometric input is valid, the process of some embodiments automatically activates (at 180) a gun release delay lock. The gun release delay lock is available in some embodiments to ensure that the defense weapon stored in the gun safe is only used for a valid emergency situation. For example, an authorized user can misjudge a situation or may even have an agenda to use the defense weapon for an improper use. The gun release delay lock of some embodiments allows central command to evaluate the scene (i.e., via the live audio and video streams) and make a determination whether to release or maintain the lock on the defense weapon.

The process 100 next receives (at 130) the signal from central command for how to proceed. In some embodiments, the signal is one of a delay signal, a release signal, and a stop signal. When a delay signal is received (at 135), the process performs at least one of signaling an error and a reactivation (at 140) of the gun release delay lock. Then the process transitions back to 130 to wait for another signal from central command. When a release signal is received (at 145), the process releases (at 150) the lock on the defense weapon (i.e., the person has full access to the gun). The process 100 of some embodiments ends after releasing the lock on the defense weapon. However, if the process did not receive a release signal, but instead received a stop signal (at 155), the process proceeds by maintaining (at 160) the lock on the defense weapon that is secured inside the gun safe (i.e., the gun safe does not release the gun). The process 100 of some embodiments ends after receiving the stop signal to maintain the gun lock. The process ends in this situation because central command has determined that an unauthorized user is attempting to access the defense weapon or an authorized user is attempting to access the defense weapon for an invalid, non-emergency situation.

In some embodiments, central command fails to provide a signal for how to proceed after a predetermined amount of time. In these cases, central command may be having difficulty evaluating the situation, or for other reasons may not be able to provide a signal that is received at the safe weapon container. In some embodiments, a predetermined amount of time is set for a time-out after which the defense weapon is released if no signal has been received from central command. In an emergency situation, the ability to access the defense weapon can mean the difference between life and death. Therefore, in some embodiments, the safe weapon container can operate independently from central command under a set of constraints that allow for release of the defense weapon. Thus, the gun may be released after the predetermined time without receiving a signal. This is beneficial because it makes the safe weapon container failsafe in emergency situations in which the central command personnel cannot or do not intercede and override the unlocking of the gun safe once a valid biometric request to open the gun safe is made. However, without a valid biometric input, the delay lock time-out has no effect. Thus, only an authorized user is able to access the defense weapon after the time-out expires without receiving a signal from central command. Furthermore, the central command personnel can still evaluate the situation after the time-out expires and the gun is released, thereby allowing all subsequent activities to be monitored and allowing the central command personnel to respond accordingly (e.g., inform the authorities of the authorized user's emergency use of a gun).

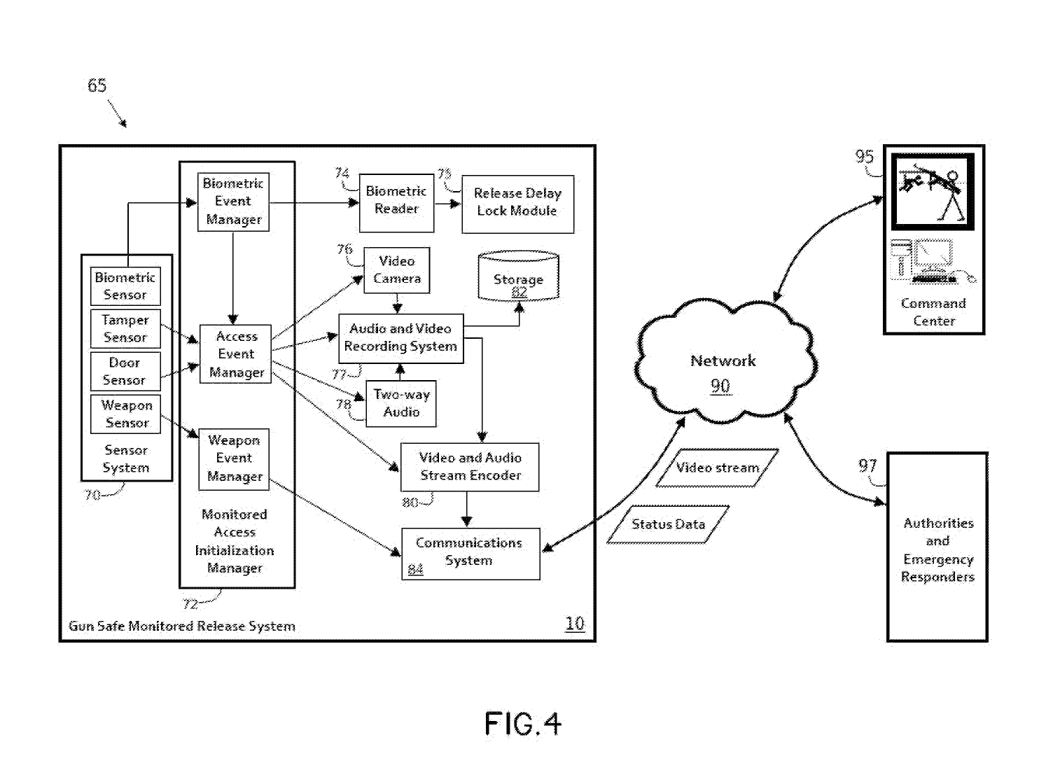

FIG. 4 conceptually illustrates another block diagram of a monitored release system of a gun safe that securitizes a defense weapon in some embodiments. The monitored release system 65 includes a number of sub-components of the monitored release system described above, by reference to FIG. 2. As shown in this figure, the sensor system 70 comprises a plurality of sensors including at least a biometric sensor, a tamper sensor, a door sensor, and a weapon sensor. The monitored access initialization manager 72 comprises a plurality of event managers including a biometric event manager, an access event manager, and a weapon event manager.

In some embodiments, the biometric sensor receives biometric input, such as a fingerprint or retina scan. For example, a user holds a finger up to a finger platform scanner located on the wall of the safe weapon container. When the biometric sensor identifies a biometric input, the biometric sensor transmits a signal to the biometric event manager. In some embodiments, the biometric event manager launches the biometric reader 74 if inactive. In some embodiments, the biometric reader starts the release delay lock module 75, to delay release of the gun upon receiving a valid biometric input.

In some embodiments, the tamper sensor identifies attempts to overcome the defense weapon lock and/or vandalize the gun safe. The tamper sensor notifies the access event manager of any such tampering. In some embodiments, the access event manager starts the video camera 76 and audio intercom 78, as well as an audio and video recording system 77, for saving recorded audio and video. The audio and video recording system 77 of some embodiments provides captured video and audio clips to a stream encoder 80 for transmission by the communications system 84 over the network 90 to the command center 95 and/or the authorities or emergency responders 97. The audio and video recording system 77 saves captured video and audio clips in the storage 82 (i.e., database). In some embodiments the recording system 77 stores raw (i.e., unprocessed and/or not encoded after native encoding by video camera capture device) video clips in the data storage 82. In some embodiments, the recording system 77 stores stream-encoded video and audio in the storage 82.

In some embodiments, the door sensor identifies the status of the cabinet door on the safe weapon container. For instance, the cabinet door may be open, closed and locked, or closed and unlocked, the status of which is instrumental for the effective use of the safe weapon container. The door sensor reports the status of the cabinet door to the access event manager, which performs initialization operations for each of the video camera 76, the audio and video recording system 77, the two-way audio 78, and the video and audio stream encoder 80, as described above.

In some embodiments, the weapon sensor receives weapon status inputs, such as movement of the defense weapon from the interior of the safe weapon container. When the weapon sensor identifies movement of the defense weapon, the weapon event manager is called which provides weapon status information to the communications system 84 for transmission to the command center 95.

Thus, in addition to third party verification (i.e., central command) prior to unlocking the gun safe, live video and audio feeds, and other communication, the gun safe of some embodiments also stores the video and audio, manages events, includes a plurality of sensors for any of several input events, and streams any or all of the events recorded to the central command facility and/r the authorities. This provides a set of records (i.e., audio recording, video recording, GUI interface inputs, etc.) of each event. In this manner, the gun safe acts like a black box on a plane.

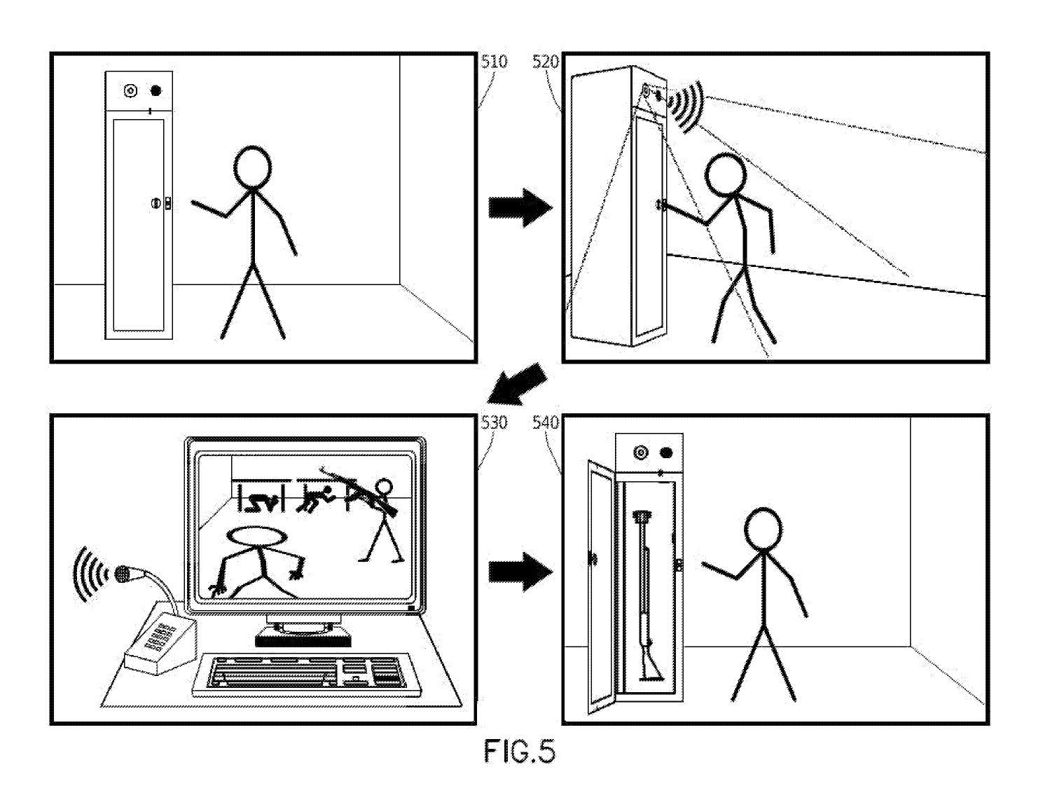

FIG. 5 conceptually illustrates an example of an authorized user accessing a shotgun from the interior of a safe weapon container during an emergency. This example usage of a safe weapon container is illustrated over four phases 510-540. In the first phase 510, a person in a room is approaching a safe weapon container. As shown, the safe weapon container includes a video camera and a two-way audio intercom at the top of the safe weapon container. There is also a biometric input device near the cabinet door handle for the safe weapon container.

In the second phase 520, the person is attempting to access the safe weapon container. In particular, the user is holding a finger up to the biometric input device in order to have a fingerprint scanned. Upon identifying the access attempt, the safe weapon container automatically starts capturing live video (as shown by the dashed lines) and audio (as shown by the curved semi-circles). Although not shown in this phase, the captured video and audio is contemporaneously being streamed to a central command facility for monitoring by central command personnel.

In the third phase 530, live video is being shown on a monitor at the central command facility. As shown in the video, an armed gunman is standing in the room while children are ducking under tables and desks. The person attempting to access the defense weapon in the safe weapon container is shown in the foreground of the video with arm held out and finger touching the biometric input device. In addition, live audio from the scene is being transmitted to the central command center, as shown by the curved semi-circles coming out of the speaker.

Next, in the fourth phase 540, the cabinet door of the safe weapon container has been opened. The person is an authorized user, since the fingerprint provided by the person was matched to an authorized user's print in the database. Also, the authorized user was granted emergency access to the gun by central command, based on its evaluation of the danger at the site and the immediate need for the authorized user to use lethal force on the armed gunman.

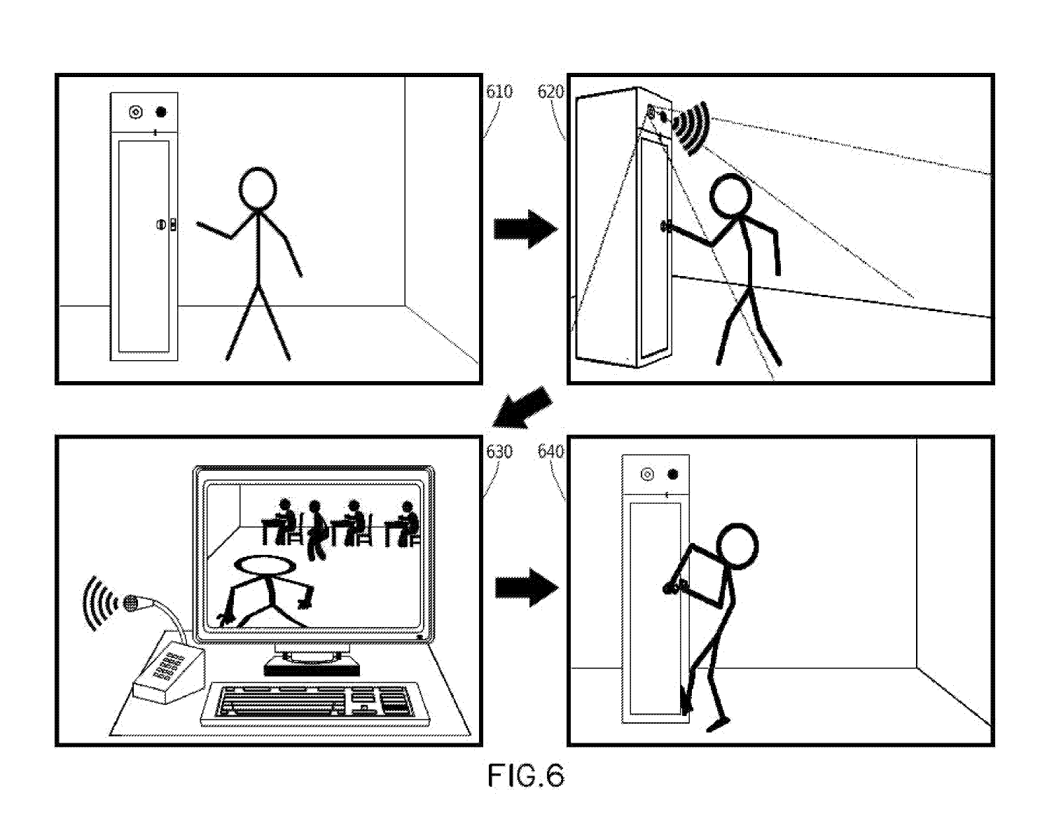

In contrast to the allowed access to the defense weapon in the FIG. 5 usage example, FIG. 6 conceptually illustrates an example of a user being denied access to a shotgun after the central command facility reviews live audio and video of a non-emergency scene. This example usage of a safe weapon container is illustrated over four phases 610-640. In the first phase 610, a person in a room is approaching a safe weapon container. When the person inputs a fingerprint, as shown in the second phase 620, the video camera begins recording video and the audio intercom is started for two-way communication with central command.

In the third phase 630, live video is being shown on a monitor at the central command facility. As shown in the video, students are seated at desks in a classroom and one student appears to be walking somewhere (e.g., to desk, out of class, etc.). No emergency situation appears anywhere in the video and the audio is in constant communication with the site. The person attempting to access the defense weapon in the safe weapon container is shown in the foreground of the video with arm held out and finger touching the biometric input device.

Next, in the fourth phase 640, the cabinet door of the safe weapon container remains closed and the safe weapon container continues to be locked. The person may be an unauthorized user or an authorized user trying to access the shot gun for an invalid use (i.e., no emergency). Thus, the person is shown struggling with the handle of the cabinet door, with no apparent way to open the door and gain access to the shot gun stored in the interior of the safe weapon container. In this way, the safe weapon container prevents unauthorized use of the defense weapon, only making it available in emergency situations that warrant use of a lethal weapon, such as a shot gun.

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

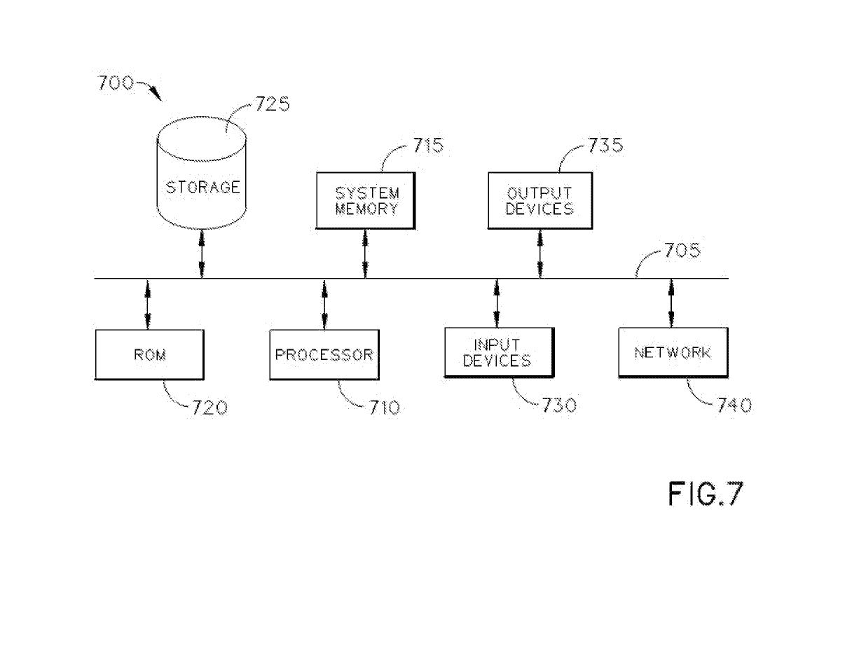

FIG. 7 conceptually illustrates an electronic system 700 with which some embodiments of the invention are implemented. The electronic system 700 may be a computer, phone, PDA, or any other sort of electronic device. Such an electronic system includes various types of computer readable media and interfaces for various other types of computer readable media. Electronic system 700 includes a bus 705, processing unit(s) 710, a system memory 715, a read-only 720, a permanent storage device 725, input devices 730, output devices 735, and a network 740.

The bus 705 collectively represents all system, peripheral, and chipset buses that communicatively connect the numerous internal devices of the electronic system 700. For instance, the bus 705 communicatively connects the processing unit(s) 710 with the read-only 720, the system memory 715, and the permanent storage device 725.

From these various memory units, the processing unit(s) 710 retrieves instructions to execute and data to process in order to execute the processes of the invention. The processing unit(s) may be a single processor or a multi-core processor in different embodiments.

The read-only-memory (ROM) 720 stores static data and instructions that are needed by the processing unit(s) 710 and other modules of the electronic system. The permanent storage device 725, on the other hand, is a read-and-write memory device. This device is a non-volatile memory unit that stores instructions and data even when the electronic system 700 is off. Some embodiments of the invention use a mass-storage device (such as a magnetic or optical disk and its corresponding disk drive) as the permanent storage device 725.

Other embodiments use a removable storage device (such as a floppy disk or a flash drive) as the permanent storage device 725. Like the permanent storage device 725, the system memory 715 is a read-and-write memory device. However, unlike storage device 725, the system memory 715 is a volatile read-and-write memory, such as a random access memory. The system memory 715 stores some of the instructions and data that the processor needs at runtime. In some embodiments, the invention's processes are stored in the system memory 715, the permanent storage device 725, and/or the read-only 720. For example, the various memory units include instructions for processing appearance alterations of displayable characters in accordance with some embodiments. From these various memory units, the processing unit(s) 710 retrieves instructions to execute and data to process in order to execute the processes of some embodiments.

The bus 705 also connects to the input and output devices 730 and 735. The input devices enable the user to communicate information and select commands to the electronic system. The input devices 730 include alphanumeric keyboards and pointing devices (also called “cursor control devices”). The output devices 735 display images generated by the electronic system 700. The output devices 735 include printers and display devices, such as cathode ray tubes (CRT) or liquid crystal displays (LCD). Some embodiments include devices such as a touchscreen that functions as both input and output devices.

Finally, as shown in FIG. 7, bus 705 also couples electronic system 700 to a network 740 through a network adapter (not shown). In this manner, the computer can be a part of a network of computers (such as a local area network (“LAN”), a wide area network (“WAN”), or an Intranet), or a network of networks (such as the Internet). Any or all components of electronic system 700 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, a process is conceptually illustrated in FIG. 3. The specific operations of this process may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details and examples, but rather is to be defined by the appended claims.

We claim:

1. A secure gun safe for releasing a defense weapon to an authorized user, the gun safe comprising:
a gun safe that securely houses a gun;
a sensor system that detects access attempts on the gun safe, said sensor system comprising a plurality of sensors that detect a plurality of access attempt events;
a surveillance camera for automatically (i) capturing video at the gun safe's location when the person tries to access the gun and (ii) streaming said captured video to a central command facility for evaluation by a trained central command operator;
an audio intercom for communicating with the central command operator at the central command facility; and
a gun release lock that physically secures the gun to the gun safe until the central command operator releases the gun to the person.

2. The secure gun safe of claim 1, wherein the plurality of sensors comprises a biometric sensor that detects a fingerprint access attempt event.

3. The secure gun safe of claim 2 further comprising a fingerprint reader that is notified of the fingerprint access attempt event detected by the biometric sensor.

4. The secure gun safe of claim 3, wherein said fingerprint reader is for (i) receiving a fingerprint input of a person trying to open the gun safe, (ii) determining whether the scanned fingerprint corresponds to an authorized user of the gun safe, and (iii) authenticating the person trying to open the gun safe when the scanned fingerprint corresponds to an authorized user of the gun safe.

5. The secure gun safe of claim 4 further comprising a gun release delay module, wherein when the scanned fingerprint corresponds to an authorized user of the gun safe, the gun release delay module automatically delays release of the gun for a predetermined amount of time.

6. The secure gun safe of claim 1, wherein the plurality of sensors comprises a tamper sensor that detects an attempt to tamper with a locked cabinet door of the gun safe to gain access to the gun.

7. The secure gun safe of claim 1 further comprising a communication system that sends and receives video, audio, and status data to and from the central command facility.

8. The secure gun safe of claim 7, wherein the communication system receives a signal for proceeding from central command, said signal being one of a delay signal, a release signal, and a stop signal.

9. The secure gun safe of claim 8, wherein the signal for proceeding is the release signal, said release signal causing the gun to be released.

10. The secure gun safe of claim 8, wherein the signal for proceeding is the stop signal, said stop signal causing the secure gun safe to maintain the lock on the gun.

11. The secure gun safe of claim 1, wherein the gun is a shot gun.

12. The secure gun safe of claim 1, wherein the gun is a hand gun.
